(19) United States
(12) Patent Application Publication
(10) Pub. No.: US 2024/0036180 A1
(43) Pub. Date: Feb. 1, 2024

(54) LONG DISTANCE LIDAR TEST SYSTEM

(71) Applicant: Continental Autonomous Mobility US, LLC, Auburn Hills, MI (US)

(72) Inventors: Nan Luo, San Dimas, CA (US); Barton M. Goldstein, Santa Barbara, CA (US); Wolfgang Schulz, Santa Barbara, CA (US)

(73) Assignee: Continental Autonomous Mobility US, LLC, Auburn Hills, MI (US)

(21) Appl. No.: 18/228,263

(22) Filed: Jul. 31, 2023

Related U.S. Application Data
(60) Provisional application No. 63/369,871, filed on Jul. 29, 2022.

(51) Int. Cl. G01S 7/497; G02B 6/26; G01S 7/481

(52) U.S. Cl. CPC G01S 7/4972; G02B 6/266; G01S 7/4818; G01S 17/931

(57) ABSTRACT

A lidar test system includes a lensed fiber collector for receiving light pulses generated by a lidar sensor. A splitter is configured to split the light pulses received from the lensed fiber collector. A first optical fiber having a first length receives one of the split light pulses. A second optical fiber having a second length also receives one of the split light pulses. The second length of the second optical fiber is longer than the first length of the first optical fiber. A switch is configured to select light transmitted through one of the optical fibers to an optical output. A variable optical attenuator (“VOA”) is configured to regulate the intensity of the light received from the switch. The lidar test system also includes a diffuser target positioned to receive light from the VOA which may be imaged by a focal plane array of the lidar assembly.

### CROSS-REFERENCE TO RELATED APPLICATIONS

This application claims the benefit of provisional application No. 63/369,871, filed on Jul. 29, 2022, which is hereby incorporated by reference.

### TECHNICAL FIELD

The technical field relates generally to a test system for lidar sensors.

### BACKGROUND

Lidar sensors are utilized in the field of autonomous driving to provide images and distance measurements around a vehicle. These sensors may have a maximum sensing distance of 500 m or more. Proper calibration of lidar sensors is important to ensure accuracy of their measurements. However, calibration is often not convenient in the field or a factory setting, where maximum sensing distance might not be available.

As such, it is desirable to present a lidar test system that allows for calibration of a lidar sensor, in terms of accuracy and precision, in a limited space. In addition, other desirable features and characteristics will become apparent from the subsequent summary and detailed description, and the appended claims, taken in conjunction with the accompanying drawings and this background.

### BRIEF SUMMARY

According to one exemplary embodiment, a lidar test system includes a lensed fiber collector for receiving light pulses generated by a lidar sensor assembly. A splitter is optically coupled with the lensed fiber collector and configured to split the light pulses received from the lensed fiber collector. The lidar test system also includes a first optical fiber having a first length and optically coupled with the splitter for receiving one of the split light pulses. The lidar test system further includes a second optical fiber having a second length and optically coupled with the splitter for receiving one of the split light pulses, the second length being longer than the first length of the first optical fiber. A switch is optically coupled with each of the optical fibers and configured to select light transmitted through one of the optical fibers to an optical output. A variable optical attenuator (“VOA”) is optically coupled with the optical output of the switch and configured to regulate the intensity of the light received from the switch. The lidar test system also includes a diffuser target positioned to receive light from the VOA which may be imaged by a focal plane array of the lidar assembly.

A method of testing a lidar sensor is also presented. The method includes receiving light pulses generated by a lidar sensor assembly with a lensed fiber collector. The method further includes splitting the light pulses received from the lensed fiber collector with a splitter optically coupled with the lensed fiber collector. The method also includes routing the light pulses output from the splitter through a first optical fiber having a first length and a second optical fiber having a second length longer than the first length.
selecting light transmitted through one the optical fibers utilizing a switch optically coupled with each of the optical fibers and delivering the light to an output;
regulating the intensity of the light received from the switch with a variable optical attenuator (“VOA”) optically coupled with the optical output of the switch; and
diffusing the light output from the VOA with a diffuser target such that the diffused light may be imaged by a detector array of the lidar sensor; and
determining calibration of the lidar sensor based on the light pulses transmitted through the first and second optical fibers and received by the detector array.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram showing a lidar test system according to an exemplary embodiment; and

FIG. 2 is a flowchart showing a method of testing a lidar sensor.

### DETAILED DESCRIPTION

Referring to the Figures, wherein like numerals indicate like parts throughout the several views, a lidar test system 100 is shown and described herein.

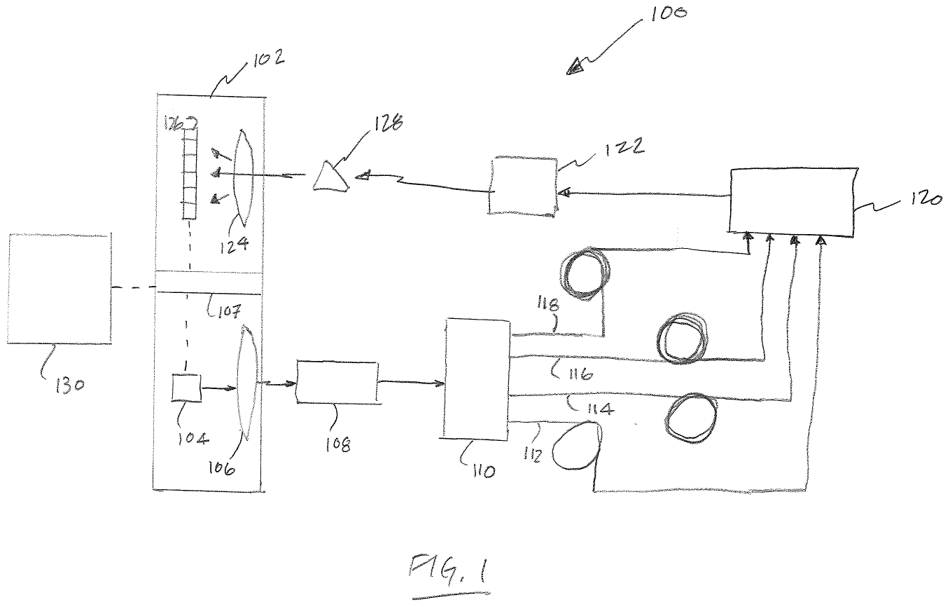

Referring to FIG. 1, the lidar test system 100 serves to test a lidar sensor assembly 102, or simply, a lidar sensor (not separately numbered) or a lidar assembly (not separately numbered). The lidar sensor assembly 102 includes a laser 104 for generating light pulses, as is appreciated by those of ordinary skill in the art. The lidar sensor assembly 102 may also include transmission optics 106, i.e., lenses, in communication with the laser 104 as is also appreciated by those of ordinary skill in the art. The lidar sensor assembly 102 may also include a controller 107. The controller 107 is in communication with the laser 104 to various aspects of the light pulses, e.g., timing, frequency, duration, intensity, etc.

The lidar test system 100 includes a lensed fiber collector 108. The lensed fiber collector 108 is configured to receive light pulses generated by the lidar assembly 102. The lensed fiber collector 108 may also be referred to as a fiber alignment stage.

The lidar test system 100 also includes a splitter 110 optically coupled with the lensed fiber collector 108. In one exemplary embodiment, a fiber optic cable 112 connects an input (not numbered) of the splitter 110 to an output (not numbered) of the lensed fiber collector 108. The splitter 110 is configured to split the light pulses received from the lensed fiber collector 108 into multiple light pulses. In the illustrated embodiment shown in FIG. 1, the splitter 110 is a 1×4 splitter (not separately numbered). As such, the splitter 110 splits the received light pulses into four identical light pulses, which are supplied to four outputs (not numbered). Of course, in other embodiments (not shown), the splitter 110 may have any number of outputs, as is appreciated by those of ordinary skill in the art.

The lidar test system 100 also includes a plurality of optical fibers 112, 114, 116, 118. In the illustrated embodiment, shown in FIG. 1, four optical fibers 112, 114, 116, 118, corresponding to the number of outputs on the splitter 110, are utilized. Each optical fiber 112, 114, 116, 118 is optically coupled with the splitter 110 for receiving one of the split light pulses. These optical fibers include a first optical fiber 112, a second optical fiber 114, a third optical fiber 116, and a fourth optical fiber 118. Of course, any number of optical fibers may be utilized in other embodiments.

In the illustrated embodiment, the optical fibers 112, 114, 116, 118 are implemented with LEAF ° optical fiber, manufactured by Corning, Inc., headquartered at One Riverfront Plaza, Corning, New York.

The optical fibers 112, 114, 116, 118 each have different lengths. The first optical fiber 112 has a first length. In the illustrated embodiment, the first length of the first optical fiber 112 is less than 25 m. In particular, the first length is about 20 m.

The second optical fiber 114 has a second length longer than the first length of the first optical fiber 112. Particularly, in the illustrated embodiment, the second length is greater than 25 m, but less than 75 m. More particularly, the second length of the second optical fiber 114 is about 50 m.

The third optical fiber 116 has a third length longer than the second length of the second optical fiber 114 (and thus longer than the first length of the first optical fiber 112). In the illustrated embodiment, the third length is greater than 75 m. More particularly, the third length of the third optical fiber 116 is about 100 m.

The fourth optical fiber 118 has a fourth length longer than the third length of the third optical fiber 116. In the illustrated embodiment, the fourth length is greater than 200 m. More particularly, the fourth length of the fourth optical fiber 118 is about 300 m.

The lidar test system 100 further includes a switch 120. The switch 120 is optically coupled to each of the optical fibers 112, 114, 116, 118. In the illustrated embodiment, the switch 120 includes four inputs (not numbered), each input being coupled to one of the optical fibers 112, 114, 116, 118, and an output (not numbered). Thus, the switch 120 may be referred to as a 4×1 switch (not separately numbered). The switch 120 is configured to select light transmitted through one of the optical fibers to the optical output. In a typical scenario, the switch 120 will sequentially select light from the first optical fiber 112, then the second optical fiber 114, then the third optical fiber 116, and finally the fourth optical fiber 118, as the lengths of the different optical fibers 112, 114, 116, 118 delay the reception of the light at the switch 120.

The lidar test system 100 also includes a variable optical attenuator (“VOA”) 122. An input (not numbered) of the VOA 122 is optically coupled to the optical output of the switch 120. The VOA 122 is configured to regulate the intensity of the light received from the switch 120. That is, the VOA 122 may increase or decrease the intensity of the light to provide a generally uniform intensity.

The lidar sensor assembly 102 may further include receive optics 124, i.e., one or more lenses to focus received light. In the illustrated embodiment, the received light is focused on an array of photodetectors 126, also commonly known as a focal plane array (not separately numbered). The photodetectors 126 convert light to electrical energy and generate an image of a scene viewed by the lidar sensor assembly, as well as assist in determining distance of objects (not shown) in the scene, as is well appreciated by those of ordinary skill in the art. The controller 107 may be in communication with the photodetectors 126 to receive electrical signals and/or images from the photodetectors 126, perform distance calculations, etc.

A diffuser target 128 may be positioned to receive light from the VOA 122. which may be imaged by a focal plane array of the lidar assembly. The diffuser target 128 disperses the light received from the VOA 122 to simulate the reflection of light from an object (not shown) typically found in the field of view of the lidar sensor 102. The light diffused by the diffuser target 128 is then received by the receive optics 124, and accordingly, the array of photodetectors 126.

The lidar test system 100 may also include a test computer 130 in communication with the lidar sensor 102, particularly, the controller 107. The test computer 130 controls operation of the lidar sensor 102 and collects data from the sensor 102. The data collected by the test computer 130 can be used to verify proper calibration of the lidar sensor 102 and allow recalibration or reconfiguration as needed.

Particularly, by utilizing the optical fibers 112, 114, 116, 118 of various lengths, the lidar test system 100 may simulate pulses of light hitting various objects (not shown) at various distances. In the case of the illustrated embodiment, the lidar test system 100 simulates objects at 20 m, 50 m, 100 m, and 300 m. The system 100 can be used for lidar range accuracy and precision investigation in a lab and/or factory environment, without using hundreds of meters of empty space.

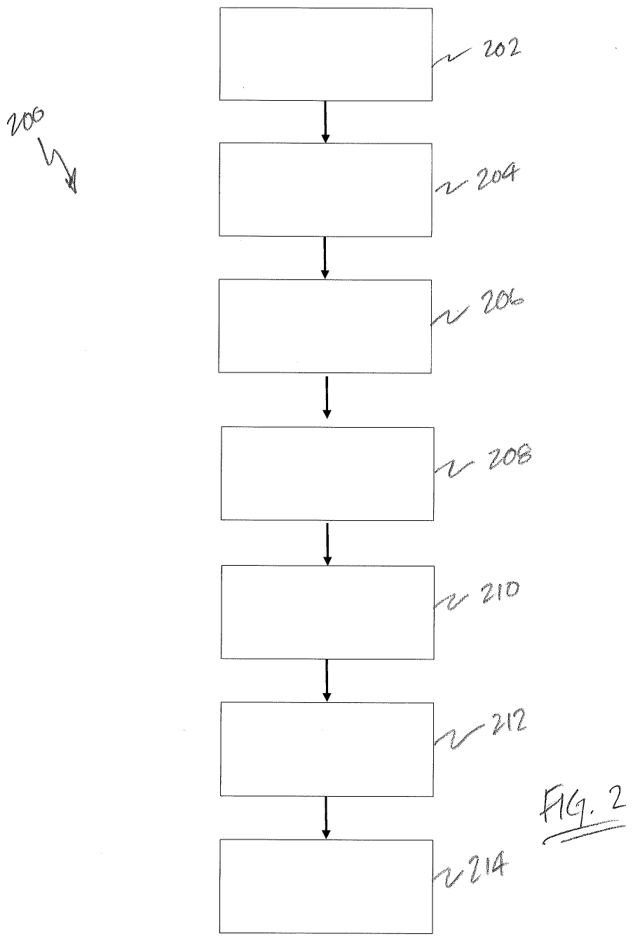

Referring now to FIG. 2, a method 200 of testing a lidar sensor is provided, according to one exemplary embodiment. The method 200, at 202, includes receiving light pulses generated by a lidar sensor assembly with a lensed fiber collector. The method 200 further includes, at 204, splitting the light pulses received from the lensed fiber collector with a splitter optically coupled with the lensed fiber collector. The method 200 also includes, at 206, routing the light pulses output from the splitter through a first optical fiber having a first length and a second optical fiber having a second length longer than the first length. The method 200 further includes, at 208, selecting light transmitted through one the optical fibers utilizing a switch optically coupled with each of the optical fibers and delivering the light to an output. The method 200 further includes, at 210, regulating the intensity of the light received from the switch with a variable optical attenuator (“VOA”) optically coupled with the optical output of the switch. The method 200 also includes, at 212, diffusing the light output from the VOA with a diffuser target such that the diffused light may be imaged by a detector array of the lidar sensor. The method 200 further includes, at 214, determining calibration of the lidar sensor based on the light pulses transmitted through the first and second optical fibers and received by the detector array.

The term “optical coupling” as used herein, may refer to any hardware and/or technique for transmitting light from one element to another. While fiber optics may be used for optical coupling, those of ordinary skill in the art may appreciate other hardware and/or techniques as well.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar test system comprising:
a lensed fiber collector for receiving light pulses generated by a lidar sensor;
a splitter optically coupled with said lensed fiber collector and configured to split the light pulses received from said lensed fiber collector;
a first optical fiber having a first length and optically coupled with said splitter for receiving one of the split light pulses;
a second optical fiber having a second length and optically coupled with said splitter for receiving one of the split light pulses, the second length being longer than the first length of said first optical fiber;
a switch optically coupled with each of said optical fibers and configured to select light transmitted through one of said optical fibers to an optical output;
a variable optical attenuator (“VOA”) optically coupled with the optical output of the switch and configured to regulate the intensity of the light received from the switch; and
a diffuser target positioned to receive light from the VOA which may be imaged by a focal plane array of the lidar sensor.

2. The system as set forth in claim 1, further comprising a third optical fiber having a third length and optically coupled with said splitter for receiving one of the split light pulses, the third length being longer than the second length of said second optical fiber.

3. The system as set forth in claim 2, further comprising a fourth optical fiber having a fourth length and in optical communication with said splitter for receiving one of the split light pulses, the fourth length being longer than the third length of said third optical fiber.

4. The system as set forth in claim 3, wherein the first length is less than 25 m, the second length is less than 75 m, the third length is greater than 75 m, and the fourth length is greater than 200 m.

5. The system as set forth in claim 1, further comprising a test computer in communication with the lidar sensor.

6. A method of testing a lidar sensor, comprising:
receiving light pulses generated by a lidar sensor assembly with a lensed fiber collector;
splitting the light pulses received from the lensed fiber collector with a splitter optically coupled with the lensed fiber collector;
routing the light pulses output from the splitter through a first optical fiber having a first length and a second optical fiber having a second length longer than the first length;
selecting light transmitted through one the optical fibers utilizing a switch optically coupled with each of the optical fibers and delivering the light to an output;
regulating the intensity of the light received from the switch with a variable optical attenuator (“VOA”) optically coupled with the optical output of the switch; and
diffusing the light output from the VOA with a diffuser target such that the diffused light may be imaged by a detector array of the lidar sensor; and
determining calibration of the lidar sensor based on the light pulses transmitted through the first and second optical fibers and received by the detector array.
